(19) United States
(12) Patent Application Publication
(10) Pub. No.: US 2025/0363772 A1
(43) Pub. Date: Nov. 27, 2025

(54) IMAGE ANALYSIS DEVICE, IMAGE PROCESSING DEVICE, IMAGE PROCESSING SYSTEM, IMAGE PROCESSING METHOD, AND NON-TRANSITORY COMPUTER-READABLE STORAGE MEDIUM

(71) Applicant: Mitsubishi Electric Corporation, Tokyo (JP)

(72) Inventor: Osamu NASU, Tokyo (JP)

(73) Assignee: Mitsubishi Electric Corporation, Tokyo (JP)

(21) Appl. No.: 19/129,293

(22) PCT Filed: Nov. 17, 2022
(86) PCT No.: PCT/JP2022/042705

§ 371 Date: May 12, 2025

(51) Int. Cl. G06V 10/75; G06V 10/74; G06V 10/94

(52) U.S. Cl. CPC G06V 10/751; G06V 10/761; G06V 10/955

(57) ABSTRACT

An image analysis device is a device to generate template information from a template image. The image analysis device includes a feature value calculation unit to calculate a feature value of each pixel in the template image and an in-block selection pixel determination unit to divide the template image into a plurality of blocks based on block division information and determine a selection pixel, as a pixel representing a feature in each block, based on the feature value.

### TECHNICAL FIELD

The present disclosure relates to an image analysis device, an image processing device, an image processing system, an image processing method and an image processing program.

### BACKGROUND ART

Template matching is widely known as a method for detecting a particular pattern in an image. The template matching is a method of comparing a previously prepared template representing a pattern that should be detected with each part of a search target image and detecting a part being the most similar to the template in the search target image as a particular pattern represented by the template.

Further, in the template matching, by extending the template to a plurality of templates by rotating, enlarging/reducing and/or transforming the template and comparing each part of the search target image with all of the plurality of extended templates, it becomes possible to perform not only the detection of a pattern being the same as the template but also detection of a pattern that has been rotated, enlarged/reduced and/or transformed due to the composition of the image capturing. However, such template matching has a problem in that it requires a process with an extremely great amount of computation. Patent Reference 1 proposes a device and a method that realizes reduction in the amount of computation by limiting pixels to be used for the comparison operation and using coarse/fine two-stage search.

### PRIOR ART REFERENCE

### Patent Reference

Patent Reference 1: Japanese Patent No. 7118295

### SUMMARY OF THE INVENTION

### Problem to be Solved by the Invention

However, in the device described in the Patent Reference 1, the pixels to be used for the template matching vary from template to template and part of the template matching includes a complicated process accompanied by branches, and thus there is a problem in that parallel processing is difficult in forming a hardware circuit.

An object of the present disclosure, which has been made in consideration of the above-described situation, is to realize template matching having a high degree of parallelism.

### Means for Solving the Problem

An image analysis device in the present disclosure is a device to generate template information from a template image, the template information including pairs of a position and a pixel value of each pixel to be used for matching for executing template matching. The image analysis device includes a feature value calculation unit to calculate a feature value of each pixel in the template image and an in-block selection pixel determination unit to divide the template image into a plurality of blocks based on block division information and determine a selection pixel, as a pixel representing a feature in each block, based on the feature value.

An image processing device in the present disclosure includes a selection pixel extraction unit to extract the selection pixels based on the block division information and the template information outputted from the image analysis device, a comparison operation unit to receive the input image, the template information, and the block division information, make a comparison between the pixel values of the selection pixels in the template image and the pixel values at positions in the input image corresponding to the selection pixels, and calculate similarity based on a result of the comparison, and a matching operation unit to perform template matching based on the similarity and outputs a result of the template matching.

### Effect of the Invention

According to the present disclosure, template matching having a high degree of parallelism can be realized.

### BRIEF DESCRIPTION OF THE DRAWINGS

FIG. 1 is a block diagram schematically showing the configuration of an image processing system according to a first embodiment.

FIGS. 2A and 2B are diagrams showing examples of the hardware configuration of the image processing system.

FIG. 3 is a diagram showing a general outline of template matching.

FIG. 4 is a diagram showing a general outline of the template matching including pixel selection.

FIG. 5 is a block diagram schematically showing the configuration of an image analysis device according to the first embodiment.

FIG. 6 is a diagram showing an example of block division of a template image.

FIG. 7 is a flowchart showing a process executed by the image analysis device according to the first embodiment.

FIG. 8 is a block diagram schematically showing the configuration of an image processing device according to the first embodiment.

FIG. 9 is a flowchart showing a process executed by the image processing device according to the first embodiment.

FIG. 10 is a block diagram schematically showing the configuration of an image processing system according to a second embodiment.

FIG. 11 is a block diagram schematically showing the configuration of an image analysis device according to the second embodiment.

FIG. 12 is a flowchart (part 1) showing a process executed by the image analysis device according to the second embodiment.

FIG. 13 is a flowchart (part 2) showing the process executed by the image analysis device according to the second embodiment.

FIG. 14 is a block diagram schematically showing the configuration of an image processing device according to the second embodiment.

FIG. 15 is a flowchart (part 1) showing a process executed by the image processing device according to the second embodiment.

FIG. 16 is a flowchart (part 2) showing the process executed by the image processing device according to the second embodiment.

### MODE FOR CARRYING OUT THE INVENTION

An image analysis device, an image processing device, an image processing system, an image processing method and an image processing program according to each embodiment will be described below with reference to the drawings. The following embodiments are just examples and it is possible to appropriately combine embodiments and appropriately modify each embodiment.

### (1) First Embodiment

### (1-1) Image Processing System 100

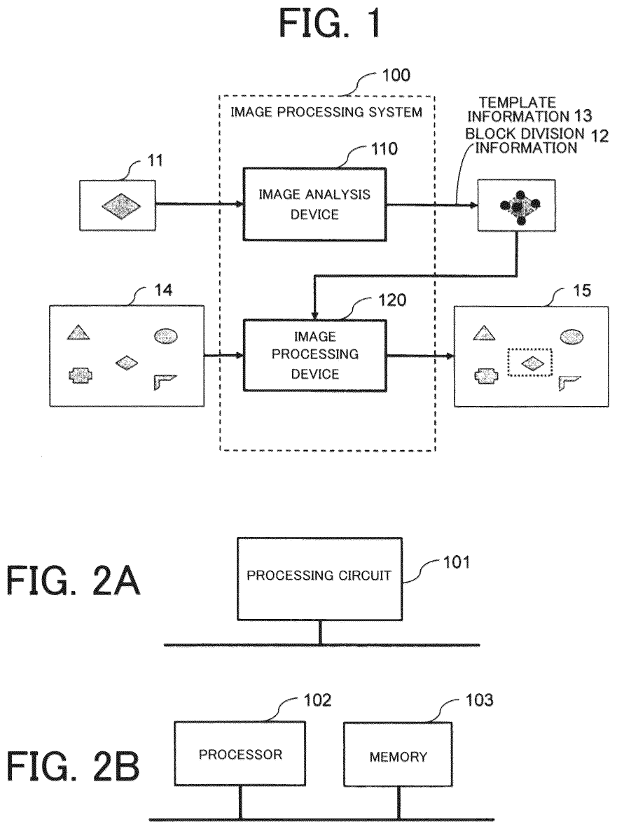

FIG. 1 is a block diagram schematically showing the configuration of an image processing system 100 according to a first embodiment. The image processing system 100 is capable of executing an image processing method according to the first embodiment. As shown in FIG. 1, the image processing system 100 includes an image analysis device 110 that receives a template image 11 as an input and outputs template information 13 and block division information 12 and an image processing device 120 that receives an input image 14, the template information 13 and the block division information 12 as inputs and outputs a matching a result 15 as the result of template matching. The template information 13 is information generated from the template image 11 and including pairs of the position and the pixel value of each pixel to be used for the matching for executing the template matching. The input image 14 is a search target image, and the image processing device 120 detects a part being the most similar to (i.e., having the highest similarity to) the template image 11 in the input image 14 as a particular pattern represented by the template. Incidentally, it is permissible even if the block division information 12 is included in a part of the template information 13.

FIGS. 2A and 2B are diagrams showing examples of the hardware configuration of the image processing system 100 according to the first embodiment. As shown in FIG. 2A, parts forming the image processing system 100 are implemented by a processing circuit 101, for example. The processing circuit 101 can be dedicated hardware or include a CPU (Central Processing Unit) as a processor that executes a program stored in a memory. In the case where the processing circuit 101 is dedicated hardware, the processing circuit 101 can be, for example, a single circuit, a combined circuit, a programmed processor, a parallelly programmed processor, an ASIC (Application Specific Integrated Circuit), an FPGA (Field Programmable Gate Array) or a combination of some of these circuits.

Alternatively, as shown in FIG. 2B, parts forming the image processing system 100 are implemented by a memory 103 as a storage device (that can be a storage medium) storing a program (e.g., an image processing program according to the first embodiment) as software and a processor 102 such as a CPU that reads out and executes the image processing program. In this case, the image processing system 100 is a computer, for example. The memory 103 is, for example, a semiconductor memory such as a RAM (Random Access Memory), a magnetic disk, or the like. Incidentally, a configuration including the processing circuit 101 in FIG. 2A and a configuration including the processor 102 and the memory 103 in FIG. 2B can coexist in the image processing system 100. While the image analysis device 110 and the image processing device 120 can be formed with a common hardware circuit (or a common computer), the image analysis device 110 and the image processing device can also be formed respectively with separate hardware circuits (or separate computers).

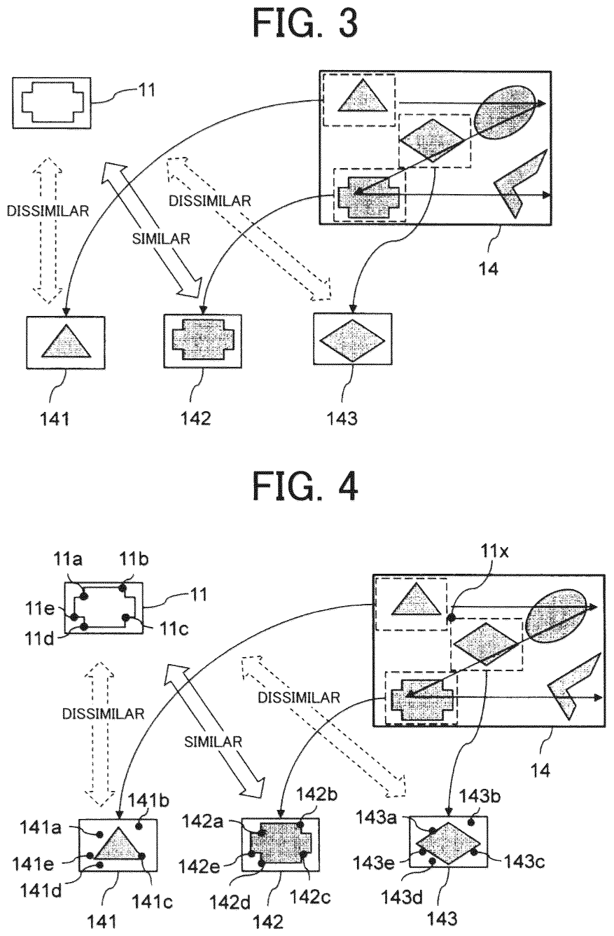

FIG. 3 is a diagram showing a general outline of the template matching. As shown in FIG. 3, the image processing system 100 performs the template matching, for detecting the position of a pattern being the same as the template image 11 in the input image 14, on the template image 11 and the input image 14. The principle of the template matching is cutting out an image region at each position having the same size as the template image 11 from the input image 14, comparing the image region cut out (e.g., cut-out regions 141-143) with the template image 11, and detecting a cut-out region being the most similar to (i.e., having the highest similarity to) the template image 11 as the matching result 15. How much the template image 11 and the cut-out regions 141-143 are similar to each other, namely, the similarity, can be defined by, for example, the sum total of squares of differences between the pixel value of each pixel of the template image 11 and the pixel value of each pixel of the cut-out regions 141-143. The similarity becomes higher with the decrease in the sum total (i.e., difference level), and the sum total equals 0 when the template image 11 and the cut-out regions 141-143 totally coincide with each other. In other words, the image processing system 100 detects a matching position that is a position where the sum total becomes the smallest (i.e., a position where the difference level becomes the smallest), as the matching result 15. Coordinates (x, y) representing the matching position are defined by the following expression (1). Incidentally, the position where the difference level becomes the smallest is a position where the similarity becomes the highest.

$$( x , y ) = {arg min}_{( x , y )} {\sum }_{i , j} {( T ( i , j ) - I ( x + i , y + j ) )}^{2} \qquad ( 1 )$$

In the expression (1), T (i, j) represents the pixel value of a pixel of the template image 11 at coordinates (i, j) and I (x+i, y+j) represents the pixel value of a pixel of the cut-out region at coordinates (x+i, y+j).

The sum total value on the right side of the expression (1) is a value called squared differences. However, the expression for obtaining the coordinates (x, y) representing the matching position is not limited to the expression (1). For example, the expression for obtaining the coordinates (x, y) representing the matching position may be defined by a different expression using normalized squared differences, cross-correlation, normalized cross-correlation, a correlation coefficient, a normalized correlation coefficient, or the like instead of the sum total of the squares of the differences.

Further, while three image regions are shown in FIG. 3 as the cut-out regions 141-143 for the sake of simplicity, the number of the cut-out regions is not limited to three.

FIG. 4 is a diagram showing a general outline of the template matching including pixel selection. While the similarity may be defined by using all the pixels in the template image 11 as shown in FIG. 3, the similarity does not necessarily have to be defined by using all the pixels in the template image 11. The similarity may also be defined to be calculated by using only previously selected pixels in the template image 11. For example, as shown in FIG. 4, it is possible to previously select pixels to be used for the calculation of the similarity from the template image 11 as selection pixels 11a-11e and calculate the similarity by using the pixel values of the pixels 11a-11e in the template image 11 and the pixel values of pixels (referred to also as “selection pixels”) 141a-141e, 142a-142e, 143a-143e at the same positions in the cut-out regions 141-143. When the matching position is calculated by using the squared differences regarding the selection pixels by a method similar to the expression (1), a calculation formula of the coordinates (x, y) representing the matching position is defined as the following expression (2):

$$( x , y ) = {arg min}_{( x , y )} \frac{1}{{\sum }_{i , j} f ( i , j )} {\sum }_{i , j} f ( i , j ) {( T ( i , j ) - I ( x + i , y + j ) )}^{2} \\ f ( i , j ) = \{ \begin{matrix}1 & ( i , j ) is selected \\ 0 & else\end{matrix} \qquad ( 2 )$$

Here, the function f(i, j) equals 1 when the pixel at the coordinates (i, j) is a selection pixel, and equals 0 otherwise.

Incidentally, while an example of selecting five pixels as the selection pixels is shown in FIG. 4 for the sake of simplicity, the number of the selection pixels and the positions of the selection pixels are not limited to the example of FIG. 4. It is generally desirable to select pixels appropriately representing a feature of the template image 11 as the selection pixels. For example, a selection pixel can be a pixel where a gradient value of the pixel value is great, a pixel at a corner of the cut-out region, a pixel selected based on a feature value (e.g., feature value such as SIFT, SURF or AKAZE), a pixel selected based on co-occurrence probability, or the like. Incidentally, the template image 11 is not limited to one image but can include a plurality of images. For example, the template image 11 can include one or more template images being basic (i.e., basic template images), one or more rotated template images obtained by rotating the basic template images, one or more enlarged or reduced template images obtained by enlarging or reducing the basic template images, one or more transformed template images obtained by transforming the basic template images, and one or more template images obtained by performing two or more processes out of the rotation, the enlargement/reduction, and the transformation on the basic template images.

### (1-2) Image Analysis Device 110

As shown in FIG. 1, the image analysis device 110 analyzes the template image 11 inputted thereto, determines the selection pixels as the pixels to be used for the calculation of the similarity, and outputs information, in which the position and the pixel value of each selection pixel have been associated with each other, as the template information 13.

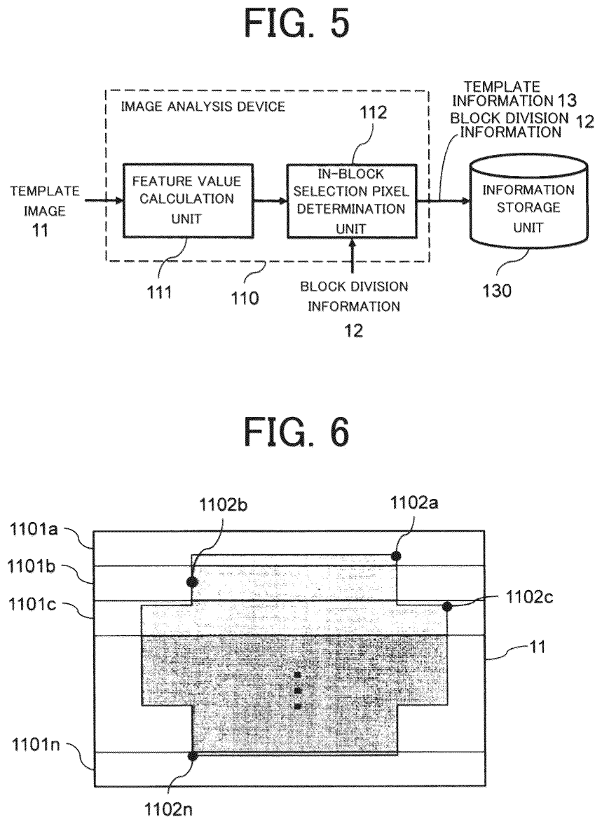

FIG. 5 is a block diagram schematically showing the configuration of the image analysis device 110 according to the first embodiment. As shown in FIG. 5, the image analysis device 110 includes a feature value calculation unit 111 and an in-block selection pixel determination unit 112. The feature value calculation unit 111 receives the template image 11 as an input, calculates a feature value of each pixel of the template image 11, and outputs the feature value. The in-block selection pixel determination unit 112 receives the feature value of each pixel of the template image 11 as an input, determines the selection pixels in regard to each block obtained by division according to the block division information 12 as a predetermined method of the block division or according to the block division information 12 inputted from outside, associates the position and the pixel value of each selection pixel with each other, and outputs the information in which the position and the pixel value of each selection pixel have been associated with each other as the template information 13.

FIG. 6 is a diagram showing an example of the block division of the template image 11. FIG. 6 is a diagram showing an example of dividing the template image 11 into a plurality of blocks 1101a-1101n. In FIG. 6, each block is a region in a rectangular shape whose vertical direction length is one pixel and lateral direction length is a plurality of pixels corresponding to the width of the template image 11. In the example of FIG. 6, one selection pixel (e.g., selection pixel 1102a-1102n) is extracted from each block. In other words, the shape and arrangement of each block, the number of selection pixels extracted from each block (i.e., selection pixel number), and a rule of the extraction of the selection pixels are included in the block division information 12 previously included or inputted from outside. Incidentally, it is permissible even if the number of selection pixels extracted from each block and the rule of the extraction of the selection pixels are not included in the block division information 12 and determined by the in-block selection pixel determination unit 112. In the example of FIG. 6, the shape of each block is a rectangular shape whose vertical direction length is one pixel and lateral direction length is the width of the template image 11, the arrangement of the plurality of blocks is an arrangement in which the blocks are arrayed in one line in the vertical direction, the number of selection pixels in each block is one, and the selection rule of the selection pixels is that the selection pixel should be extracted from a corner or a boundary part of each block. However, the shape and the arrangement of each block, the selection rule of the selection pixels, and the number of selection pixels are not limited to the above-described example. Incidentally, in the plurality of blocks obtained by the block division according to the block division information 12, it is permissible even if adjoining blocks overlap with each other (i.e., have an overlapping region). Further, the area of each block does not need to be equal to each other and may be changed depending on the position in the template image. For example, it is possible to decrease the area of each block with the decrease in the distance from the center of the image and increase the area of each block with the increase in the distance from the center of the image (i.e., with the decrease in the distance from the periphery of the image).

As shown in FIG. 5, the template information 13 outputted from the in-block selection pixel determination unit 112 is stored in an information storage unit 130 as a storage device. The information storage unit 130 can also be a part of the image processing system 100 or the image analysis device 110. The information storage unit 130 can also be a part of a separate device (e.g., a server on a network) capable of communicating with the image processing system 100 or the image analysis device 110.

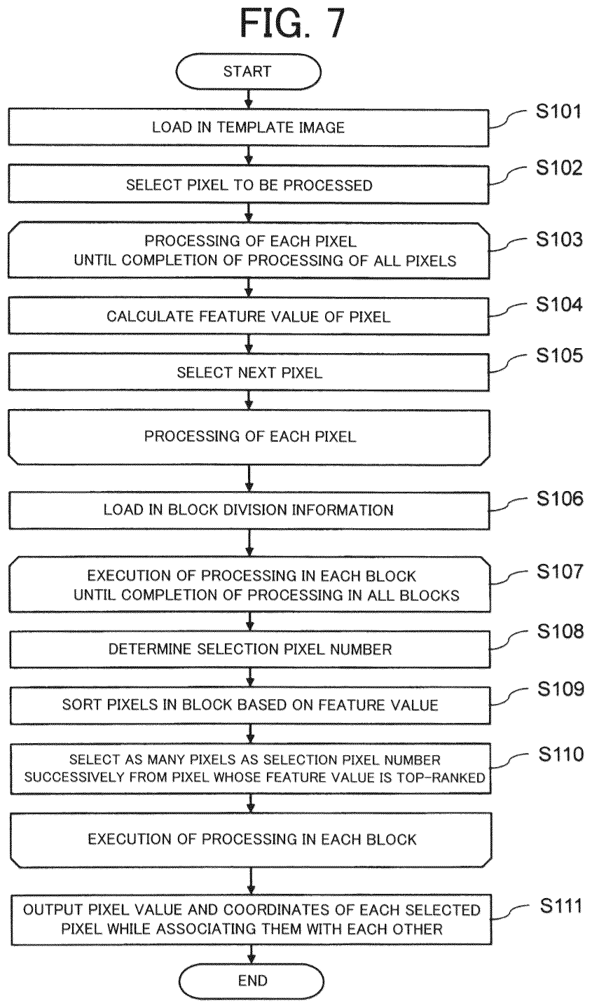

FIG. 7 is a flowchart showing a process executed by the image analysis device 110 according to the first embodiment. First, the feature value calculation unit 111 loads in the template image 11 (step S101) and selects a pixel to be processed (step S102). While there is no restriction on the pixel to be processed first, a pixel at a top left corner of the template image 11 is generally selected as the pixel to be processed first.

The feature value calculation unit 111 calculates the feature value regarding the selection pixel (step S104) and selects a pixel to be processed next (step S105). While there is no restriction on the way of selecting the next pixel, the next pixel is generally selected in order of raster scan. While the feature value calculated may be a value of any kind, the feature value can be, for example, the gradient value of the pixel value, a corner index, the SIFT feature value, the SURF feature value, the AKAZE feature value, the co-occurrence probability, or the like. The processing of the steps S104 to S105 is repeated until the processing is applied to all the pixels in the template image 11 (step S103). That is, the processing of the steps S103 to S105 is executed by the feature value calculation unit 111.

Subsequently, the in-block selection pixel determination unit 112 loads in the block division information 12 (step S106). The block division information 12 may be either previously stored in the image analysis device 110 or inputted from outside. For each block based on the block division information 12 (step S107), the in-block selection pixel determination unit 112 determines the selection pixel number as the number of selection pixels in the block (step S108), sorts the pixels in the block based on the feature value (step S109), and selects as many pixels as the selection pixel number successively from a pixel whose feature value is top-ranked (step S110). The selection pixel number may be either a predetermined number of pixels or the number of pixels determined based on the block division information 12 (e.g., at least one of the shape, the number of pixels and the arrangement of each block and another rule).

The in-block selection pixel determination unit 112 may determine the selection pixel number at a number proportional to the size of the block, for example. Alternatively, the selection pixel number may be determined for each block by inverse calculation from a circuit scale permissible for the hardware implemented as the image analysis device 110. Further, while the selection pixel number is calculated for each block, it is permissible even if the selection pixel number of each block is the same number for all the blocks.

It is also permissible even if there are blocks from which no selection pixel is selected (i.e., blocks whose selection pixel number is 0) among all the blocks. Further, it is permissible even if there are blocks from which no selection pixel is selected and blocks from which a selection pixel is selected among all the blocks and the selection pixel number is the same number for all the blocks from which a selection pixel is selected. Furthermore, it is permissible even if there are blocks from which no selection pixel is selected and blocks from which a selection pixel is selected among all the blocks and the selection pixel number of each block from which a selection pixel is selected is set at a minimum selection pixel number or a selection pixel number as an integral multiple of the minimum selection pixel number.

Further, the pixel selection (step S110) is not limited to the method of simply selecting as many pixels as the selection pixel number successively from a pixel whose feature value is top-ranked. In the pixel selection, a feature value selection pixel determined based on the feature value and vicinal pixels in the vicinity of the feature value selection pixel may be selected as the selection pixels. For example, in the pixel selection, a feature value selection pixel whose feature value is top-ranked and vicinal pixels adjoining the feature value selection pixel may be selected as the selection pixels. Further, in the pixel selection, a feature value selection pixel whose feature value is top-ranked and vicinal pixels at a constant distance from the feature value selection pixel may be selected as the selection pixels. As above, when there is a vicinal pixel, the selection pixel number is the sum total of the number of feature value selection pixels and the number of vicinal pixels.

As a more concrete example, when a feature value selection pixel determined based on the feature value and vicinal pixels as four pixels: top, bottom, left and right pixels, adjoining the feature value selection pixel are determined as the selection pixels, these five pixels are the selection pixels.

As another example, when a feature value selection pixel determined based on the feature value and a vicinal pixel as a pixel to the right of the feature value selection pixel at a distance of four pixels are selected as the selection pixels, these two pixels are the selection pixels.

By placing restrictions on the selection pixel number of each block and the positional relationship of the pixels to be selected as shown in the above examples, a circuit performing the extraction of the selection pixels can be constructed efficiently in cases where the image analysis device 110 is formed with a hardware circuit.

Finally, the in-block selection pixel determination unit 112 associates the pixel value and the coordinates of each selection pixel with each other in regard to all the pixels selected in each block, and outputs the information in which the pixel value and the coordinates of each selection pixel have been associated with each other as the template information 13 (step S111).

### (1-3) Image Processing Device 120

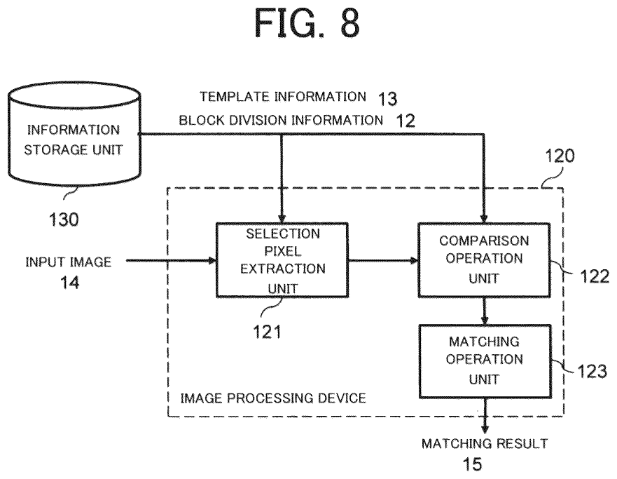

FIG. 8 is a block diagram schematically showing the configuration of the image processing device 120 according to the first embodiment. As shown in FIG. 8, the image processing device 120 includes a selection pixel extraction unit 121, a comparison operation unit 122 and a matching operation unit 123. The selection pixel extraction unit 121 receives an input of the template information 13 from the information storage unit 130, receives an input of the input image 14, and outputs pixel information on the template image 11 to be used for the matching operation and pixel information on the input image 14. The comparison operation unit 122 receives an input of the pixel information outputted by the selection pixel extraction unit 121, receives an input of the template information 13 from the information storage unit 130, and performs a pixel value comparison operation between the input image 14 and the template information 13. The matching operation unit 123 receives the result of the operation by the comparison operation unit 122, calculates a position in the input image 14 being the most similar to the template image 11, and outputs the coordinates of the position as the matching result 15.

Incidentally, the selection pixel extraction unit 121 may be implemented by a hardware circuit for the pixel selection prepared corresponding to the predetermined method of the block division or the block division information 12 inputted from outside used by the image analysis device 110.

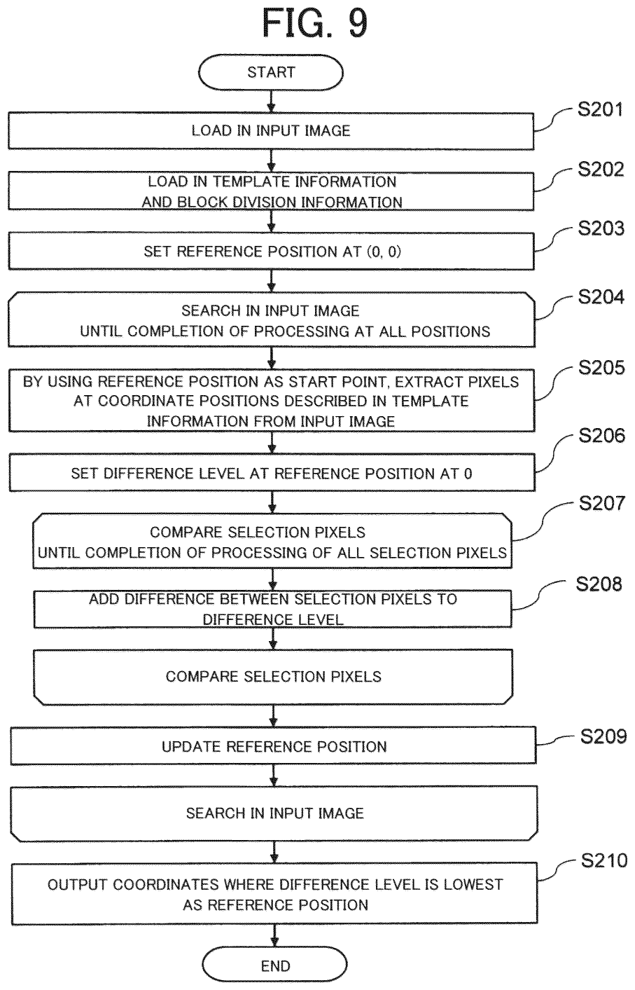

FIG. 9 is a flowchart showing a process executed by the image processing device 120 according to the first embodiment. First, the selection pixel extraction unit 121 loads in the input image 14, the template information 13 and the block division information 12 (steps S201 and S202). Subsequently, the selection pixel extraction unit 121 sets a reference position at coordinates (0, 0) (step S203), extracts the pixel value and position information regarding each pixel selected from the template image 11 included in the template information 13, and extracts pixels at positions whose relative distances from the reference position as a start point coincide with the position information included in the template information 13 from the input image 14 as the selection pixels, while associating the extracted pixels with the pixels extracted from the template image 11 included in the template information 13 and corresponding to the position information (step S205).

For example, to explain this step by taking FIG. 4 as an example, when the reference position is set at the pixel 11x in the input image 14, pixels corresponding to the selection pixels 11a-11e in the template image 11 are selected from the input image 14 so that their relative positions from the reference position correspond to the positions of the selection pixels 11a -11e, and thus those selected pixels are the pixels 143a-143e in FIG. 4. To sum up, it can be said that setting the reference position at the pixel 11x means a process of comparing the similarity between the template image 11 and the region 142 cut out from the input image 14 in the same shape as the template image 11 and having the pixel 11x at the reference position as the start point.

Returning to FIG. 9, the comparison operation unit 122 previously sets the difference level at the reference position at 0 as an initial value (step S206), calculates the difference between the pixel value of the pixel selected from the template image 11 and the pixel value of the selection pixel extracted from the input image 14 associated with the pixel, and adds the calculated difference to the difference level (step S208). The comparison operation unit 122 executes the calculation of the difference level at the reference position by performing this addition process for all of the selected pixels (steps S207 and 208). Here, since the calculated difference level is the sum total of the differences between pixels, image patterns are more similar to each other with the decrease in the difference level (i.e., the similarity is higher with the decrease in the difference level). Incidentally, the difference mentioned here can be the absolute value of the difference between two pixel values, or the square of the difference between two pixel values. Further, while the difference level shown in the step S208 is the sum total of the differences, the difference level may also be defined by cross-correlation, normalized cross-correlation, a correlation coefficient, a normalized correlation coefficient, or the like instead of the differences.

The comparison operation unit 122 calculates the difference level as described above in regard to all positions in the input image 14 (step S204) while successively updating the reference position (step S209), and the matching operation unit 123 outputs a reference position where the difference level is the lowest as the matching result 15 of the pattern matching (step S210).

Incidentally, while the method of updating the reference position is generally the update in order of raster scan, a different update method may be employed. Further, in the case of using cross-correlation, normalized cross-correlation, a correlation coefficient, a normalized correlation coefficient, or the like instead of the difference operation, an increase in the numerical value means that the image patterns are more similar to each other, and thus the difference level in this case has a character like the similarity.

### (1-4) Advantage

According to the first embodiment, a required processing computation amount can be set by adjusting the selection pixel number in each block. Therefore, even in cases where the image processing system 100 is formed with a hardware circuit, the block division information and the selection pixel numbers can be determined in consideration of the operation speed and the degree of parallelism implementable by the hardware circuit.

### (2) Second Embodiment

### (2-1) Image Processing System 200

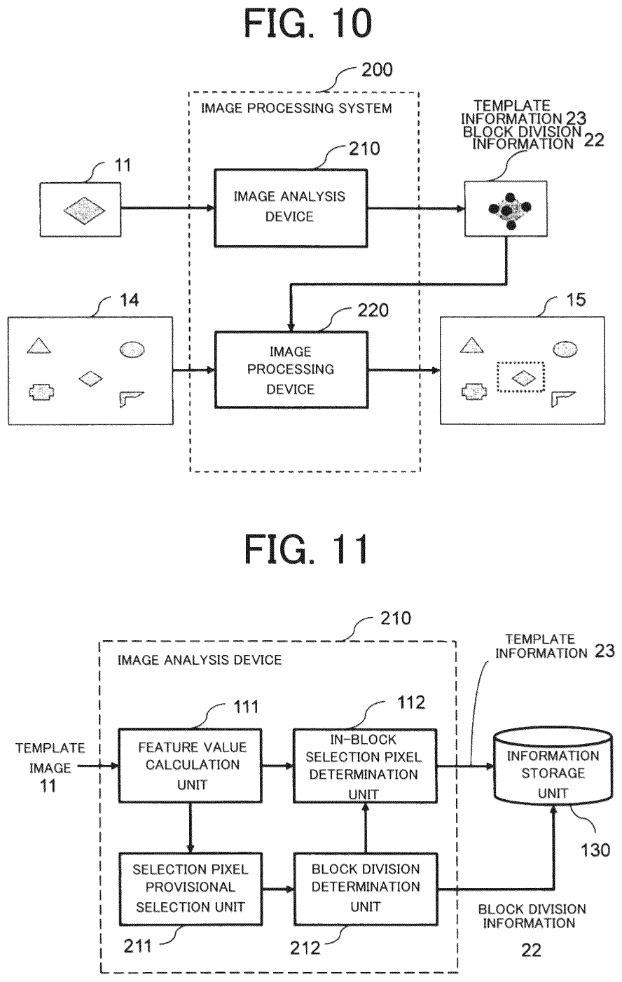

FIG. 10 is a block diagram schematically showing the configuration of an image processing system 200 according to a second embodiment. The image processing system 200 is capable of executing an image processing method according to the second embodiment. The description of the second embodiment will be given mainly of differences from the above-described first embodiment. As shown in FIG. 10, the image processing system 200 includes an image analysis device 210 that receives the template image 11 as an input and outputs template information 23 and block division information 22 and an image processing device 220 that receives the input image 14, the template information 23 and the block division information 22 as inputs and outputs the matching result 15 as the result of the template matching. The template information 23 is information generated from the template image 11 and including pairs of the position and the pixel value of each pixel to be used for the matching for executing the template matching. The input image 14 is a search target image, and the image processing device 220 detects a part being the most similar to (i.e., having the highest similarity to) the template image 11 in the input image 14 as a particular pattern represented by the template. Incidentally, examples of the hardware configuration of the image processing system 200 are the same as those shown in FIGS. 2A and 2B. Further, the template image 11 is not limited to one image but can include a plurality of images. Similarly to the case in the first embodiment, the template image 11 may include one or more basic template images, one or more rotated template images, one or more enlarged or reduced template images, one or more transformed template images, and one or more template images obtained by performing two or more processes out of the rotation, the enlargement/reduction, and the transformation on the basic template images.

### (2-2) Image Analysis Device 210

FIG. 11 is a block diagram schematically showing the configuration of the image analysis device 210 according to the second embodiment. In FIG. 11, each component identical or corresponding to a component shown in FIG. 5 is assigned the same reference character as in FIG. 5. The image analysis device 210 according to the second embodiment differs from the image analysis device 110 according to the first embodiment in further including a selection pixel provisional selection unit 211 and a block division determination unit 212.

The selection pixel provisional selection unit 211 receives the feature value of each pixel of the template image 11 from the feature value calculation unit 111 and selects a predetermined number of provisional selection pixels from the whole of the template image 11. Incidentally, the provisional selection pixels selected by the selection pixel provisional selection unit 211 and the selection pixels selected from each block by the in-block selection pixel determination unit 112 are irrelevant to each other. The block division determination unit 212 determines a block division method based on distribution of the provisional selection pixels selected by the selection pixel provisional selection unit 211 and outputs the block division information 22 as information indicating the block division method to the in-block selection pixel determination unit 112 and the information storage unit 130. While the in-block selection pixel determination unit 112 in the first embodiment uses a predetermined block division method or receives the input of the block division information 12 from outside, the in-block selection pixel determination unit 112 in the second embodiment uses the block division information 22 outputted by the block division determination unit 212 instead.

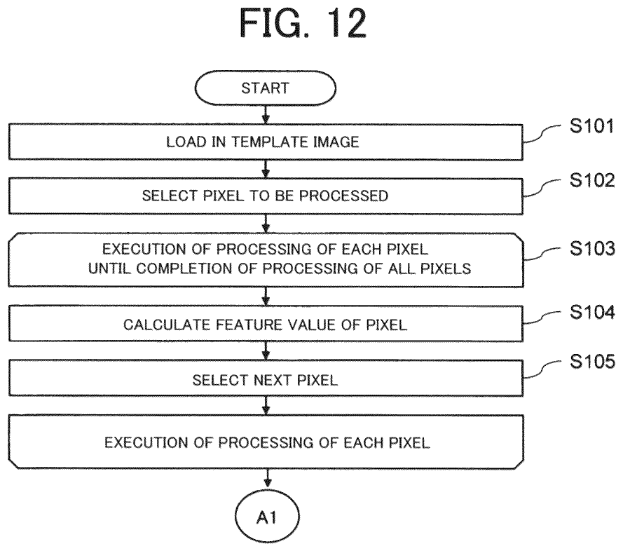

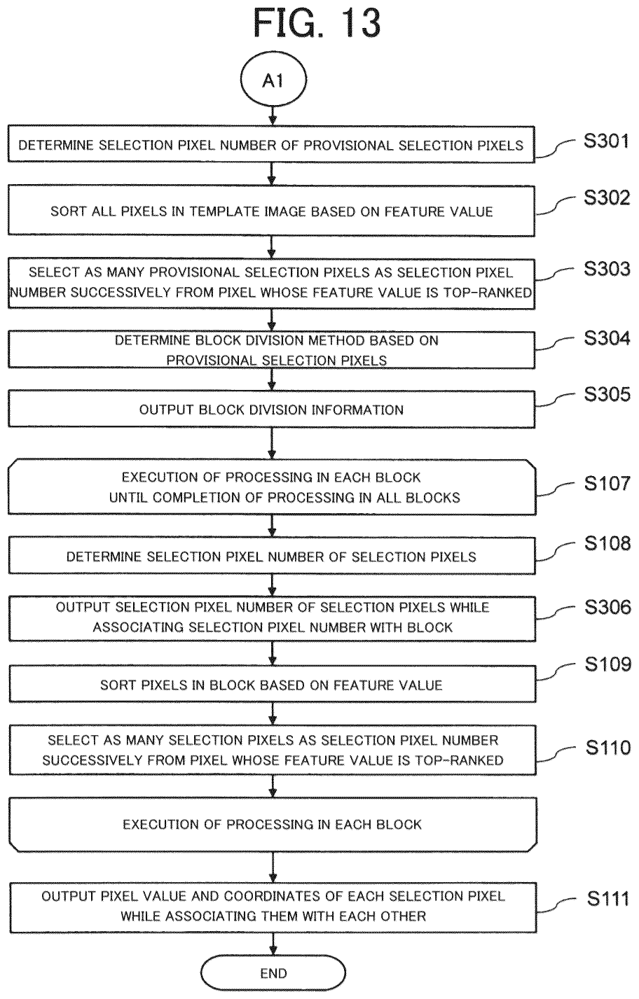

FIG. 12 and FIG. 13 are flowcharts (part 1, part 2) showing a process executed by the image analysis device 210 according to the second embodiment. In FIG. 12 and FIG. 13, each step identical or corresponding to a step shown in FIG. 7 is assigned the same reference character as in FIG. 7.

As shown in FIG. 12 and FIG. 13, the image analysis device 210 according to the second embodiment executes the following processing in addition to the processing by the image analysis device 210 according to the first embodiment. After the calculation of the feature value of each pixel by the feature value calculation unit 111 (steps S103-S105), the selection pixel provisional selection unit 211 determines the selection pixel number of the provisional selection pixels to be selected (step S301), sorts all the pixels in the template image 11 based on the feature value (step S302), and thereafter selects as many provisional selection pixels as the selection pixel number successively from a pixel whose feature value is top-ranked (step S303). The selection pixel number of the provisional selection pixels may be set at a predetermined value, determined based on the size of the template image 11, calculated based on the feature value of each pixel calculated by the feature value calculation unit 111, or determined by a combination of some of these methods.

Further, similarly to the case where the in-block selection pixel determination unit 112 in the first embodiment performs the pixel selection in each block, the selection pixel provisional selection unit 211 may not only simply perform the successive selection of pixels whose feature values are top-ranked as the provisional selection pixels but also select a pixel whose feature value is top-ranked and the vicinal pixels of the pixel as the provisional selection pixels. This vicinal pixel is, for example, a pixel adjoining the pixel whose feature value is top-ranked, a pixel at a constant distance from the pixel whose feature value is top-ranked, or the like.

The block division determination unit 212 determines the block division method based on the provisional selection pixels selected as above (step S304) and outputs the determined block division method as the block division information 22 (step S305). In the block division method indicated by the block division information 22, as shown in FIG. 6, for example, the shape of each block is a rectangular shape whose vertical direction length is one pixel and lateral direction length is the width of the template image 11, and the arrangement of the plurality of blocks is an arrangement in which the blocks are arrayed in one line in the vertical direction. The method of determining the block division method by the block division determination unit 212 is a method, for example, to comply with one or more of the following conditions: a condition that the number of provisional selection pixels selected by the selection pixel provisional selection unit 211 in each block is the same as each other, a condition that the number of provisional selection pixels in each block is a minimum value or a constant multiple (e.g., an integral multiple) of the minimum value, a condition that a maximum value of the number of provisional selection pixels in each block does not exceed a predetermined value, and a condition that variance of the positions of the pixels selected by the selection pixel provisional selection unit 211 in each block becomes large or small. Further, the block division method can be a method, for example, to comply with one or more of the following methods: a method of dividing the image so that a vertical width of each block becomes the same as each other, a method of dividing the image so that a horizontal width of each block becomes the same as each other, and a method of dividing the image so that the variance of the areas of the blocks becomes small. Incidentally, in the plurality of blocks obtained by the division according to the block division method determined by the block division determination unit 212, it is permissible even if adjoining blocks overlap with each other (i.e., have an overlapping region). Further, the area of each block does not need to be equal to each other and may be changed depending on the position in the template image. For example, it is possible to decrease the area of each block with the decrease in the distance from the center of the image and increase the area of each block with the increase in the distance from the center of the image (i.e., with the decrease in the distance from the periphery of the image).

### (2-3) Image Processing Device 220

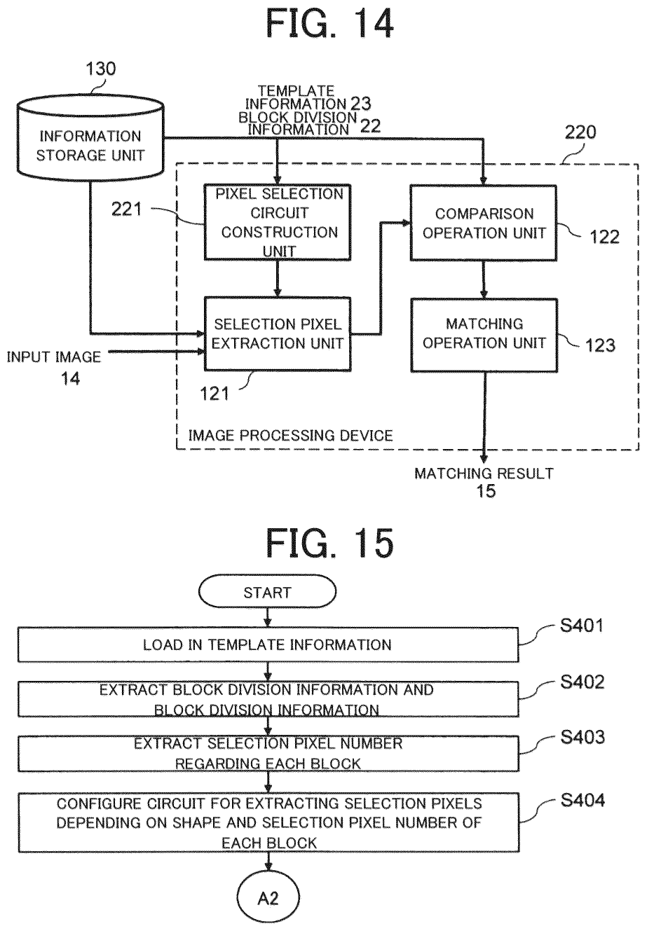

FIG. 14 is a block diagram schematically showing the configuration of the image processing device 220 according to the second embodiment. In FIG. 14, each component identical or corresponding to a component shown in FIG. 8 is assigned the same reference character as in FIG. 8. The image processing device 220 according to the second embodiment differs from the image processing device 120 according to the first embodiment in further including a pixel selection circuit construction unit 221.

The image processing device 220 includes the selection pixel extraction unit 121 that extracts the selection pixels based on the template information 23 and the block division information 22 outputted from the image analysis device 210, the comparison operation unit 122 that receives the input image 14, the template information 23 and the block division information 22, makes a comparison between the pixel values of the selection pixels in the template image and the pixel values at positions in the input image 14 corresponding to the selection pixels, and calculates the similarity based on the result of the comparison, the matching operation unit 123 that performs the template matching based on the similarity and outputs matching result 15 as the result of the template matching, and the pixel selection circuit construction unit 221. The selection pixel extraction unit 121 includes an arithmetic circuit constructed so that its configuration can be modified, and the pixel selection circuit construction unit 221 constructs an arithmetic circuit (e.g., switches the state of a switching element forming the circuit) based on the template information and the block division information.

The pixel selection circuit construction unit 221 receives the block division information 22 from the information storage unit 130 and constructs the circuit configuration of the hardware circuit of the selection pixel extraction unit 121 that extracts the selection pixels. The selection pixel extraction unit 121 extracts the selection pixels with the hardware circuit constructed by the pixel selection circuit construction unit 221. The hardware circuit constructed by the pixel selection circuit construction unit 221 (i.e., the hardware circuit included in the selection pixel extraction unit 121) can be implemented by a device capable of dynamic circuit construction such as an FPGA, for example.

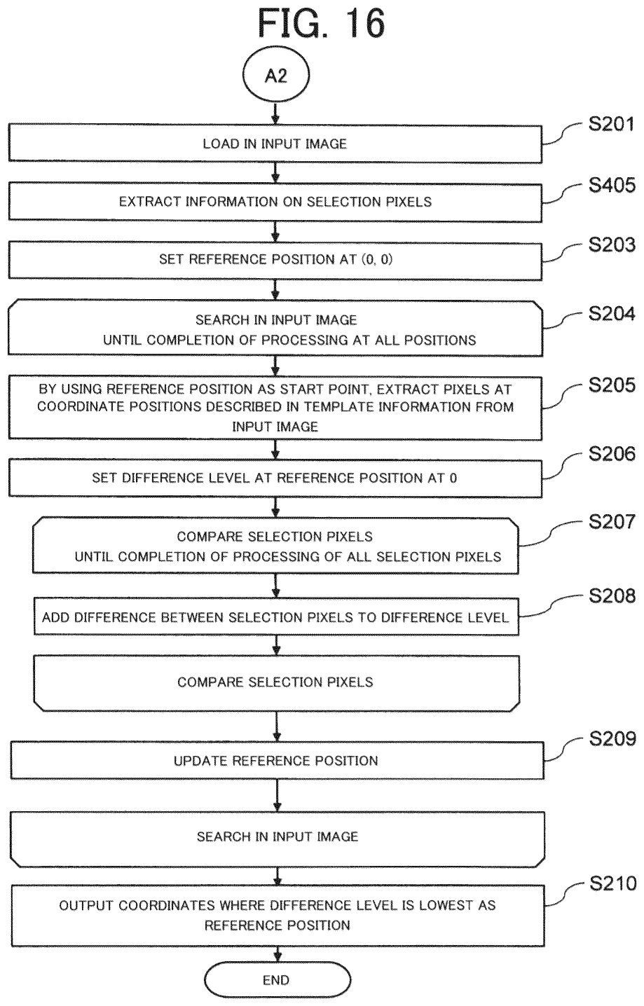

FIG. 15 and FIG. 16 are flowcharts (part 1, part 2) showing a process executed by the image processing device 220 according to the second embodiment. In FIG. 15 and FIG. 16, each step identical or corresponding to a step shown in FIG. 9 is assigned the same reference character as in FIG. 9.

The image processing device 220 according to the second embodiment executes the following processing in addition to the processing by the image analysis device 210 according to the first embodiment. First, the pixel selection circuit construction unit 221 loads in the template information 13 and the block division information 22 (step S401) and extracts the block division information 22 (step S402). The pixel selection circuit construction unit 221 extracts the selection pixel number of each block from the extracted block division information 22 (step S403) and configures the circuit for extracting the selection pixels (i.e., the hardware circuit as the arithmetic circuit included in the selection pixel extraction unit 121) depending on the shape of each block and the selection pixel number of each block (step S404). While the method of the circuit configuration is not particularly limited, the pixel selection circuit construction unit 221 determines the circuit configuration in consideration of, for example, one or more items of information out of the maximum value of the selection pixel number in each block, a circuit scale that can be configured in a device such as an FPGA forming the circuit, and the degree of parallelism of processing matching with a required operation speed. Especially, the pixel selection circuit construction unit 221 may perform the parallelization of the circuit in consideration of the restrictions used by the in-block selection pixel determination unit 112 for the pixel selection. For example, in the case where five pixels including a feature value selection pixel selected based on the feature value and four vicinal pixels as top, bottom, left and right vicinal pixels adjoining the feature value selection pixel are determined as the selection pixels, the pixel selection circuit construction unit 221 constructs a circuit capable of simultaneously reading out the values of these five pixels.

Further, the pixel selection circuit construction unit 221 may configure the circuit in consideration of the update of the reference position so that the position of the data read out can be updated corresponding to the update of the reference position by shifting stored values in the device in regard to the device such as a register, a memory or the like storing pixel values as sources of the readout.

Furthermore, the pixel selection circuit construction unit 221 may previously construct a selector circuit for selecting a block when the pixel values of the selection pixels are read out in sequence from each block. For example, the block may be determined by cyclically switching the selector circuit. After the loading in of the input image 14 (step S201), selection pixel information is extracted from the template information already loaded in in the step S401 (step S405).

### (2-4) Advantage

According to the second embodiment, a required processing computation amount can be set by adjusting the selection pixel number in each block. Therefore, even in cases where the image processing system 200 (e.g., the selection pixel extraction unit 121) is formed with a hardware circuit, the block division information 22 and the selection pixel number in each block can be determined in consideration of the operation speed and the degree of parallelism implementable by the hardware circuit.

Further, according to the second embodiment, since the pixel selection circuit construction unit 221 constructs the hardware circuit as the arithmetic circuit based on the template information 23 and the block division information 22, the operation speed and the degree of parallelism implementable by the hardware circuit can be set appropriately.

### DESCRIPTION OF REFERENCE CHARACTERS

11: template image, 12, 22: block division information, 13, 23: template information, 14: input image, 15: matching result, 100, 200: image processing system, 110, 210: image analysis device, 111: feature value calculation unit, 112: in-block selection pixel determination unit, 120, 220: image processing device, 121: selection pixel extraction unit, 122: comparison operation unit, 123: matching operation unit, 130: information storage unit, 211: selection pixel provisional selection unit, 212: block division determination unit, 221: pixel selection circuit construction unit, 1101a-1101n: block, 1102a-1102n: selection pixel, 11x: pixel at reference position

1. An image analysis device to generate template information from a template image, the template information including pairs of a position and a pixel value of each pixel to be used for matching for executing template matching, the image analysis device comprising:
feature value calculation circuitry to calculate a feature value of each pixel in the template image; and
in-block selection pixel determination circuitry to divide the template image into a plurality of blocks based on block division information and determine a selection pixel, as a pixel representing a feature in each block, based on the feature value.

2. The image analysis device according to claim 1, wherein the in-block selection pixel determination circuitry determines a selection pixel number, as the number of the selection pixels in each block in the template image, based on at least either of a shape of each block or the number of pixels in each block.

3. The image analysis device according to claim 2, wherein the in-block selection pixel determination circuitry determines a maximum value of the selection pixel number to be less than or equal to a predetermined value.

4. The image analysis device according to claim 2, wherein the in-block selection pixel determination circuitry determines the selection pixel number in each block so that the plurality of blocks include a first block and a second block, the selection pixel number of the first block being 0, the selection pixel number of the second block is a predetermined number.

5. The image analysis device according to claim 1, wherein the in-block selection pixel determination circuitry previously holds the block division information or receives the block division information from outside.

6. The image analysis device according to claim 1, wherein the block division information includes a shape, size, and arrangement of each block in the template image.

7. The image analysis device according to claim 1, wherein the block division information includes a selection pixel number as the number of the selection pixels in each block in the template image.

8. The image analysis device according to claim 1, further comprising:
selection pixel provisional selection circuitry to select provisional selection pixels from a whole of the template image based on the feature value calculated by the feature value calculation unit; and
block division determination circuitry to determine the block division information based on a distribution state of the provisional selection pixels.

9. An image processing device comprising:
selection pixel extraction circuitry to extract the selection pixels based on the block division information and the template information outputted from the image analysis device according to claim 1;
comparison operation circuitry to receive an input image, the template information, and the block division information, make a comparison between the pixel values of the selection pixels in the template image and the pixel values at positions in the input image corresponding to the selection pixels, and calculate similarity based on a result of the comparison; and
matching operation circuitry to perform template matching based on the similarity and outputs a result of the template matching.

10. The image processing device according to claim 9, further comprising a pixel selection circuit construction unit, wherein
the selection pixel extraction circuitry includes an arithmetic circuit constructed to be modifiable, and
the pixel selection circuit construction circuitry constructs the arithmetic circuit based on the template information and the block division information.

11. An image processing system comprising:
the image analysis device according to claim 1; and
an image processing device,
wherein the image processing device includes:
selection pixel extraction circuitry to extract the selection pixels based on the block division information and the template information outputted from the image analysis device;
comparison operation circuitry to receive an input image, the template information, and the block division information, makes a comparison between the pixel values of the selection pixels in the template image and the pixel values at positions in the input image corresponding to the selection pixels, and calculates similarity based on a result of the comparison; and
matching operation circuitry to perform template matching based on the similarity and outputs a result of the template matching.

12. An image processing method to generate template information from a template image, the template information including pairs of a position and a pixel value of each pixel to be used for matching for executing template matching, the image processing method comprising:
calculating a feature value of each pixel in the template image; and
dividing the template image into a plurality of blocks based on block division information and determining a selection pixel, as a pixel representing a feature in each block, based on the feature value.

13. A non-transitory computer-readable storage medium storing an image processing program to be executed by a computer to generate template information from a template image, the template information including pairs of a position and a pixel value of each pixel to be used for matching for executing template matching, wherein the image processing program causes the computer to execute:
a step of calculating a feature value of each pixel in the template image; and
a step of dividing the template image into a plurality of blocks based on block division information and determining a selection pixel, as a pixel representing a feature in each block, based on the feature value.

14. The image analysis device according to claim 3, wherein the in-block selection pixel determination circuitry determines the selection pixel number in each block so that the plurality of blocks include a first block and a second block, the selection pixel number of the first block being 0, the selection pixel number of the second block is a predetermined number.
